(19) United States
(12) Patent Application Publication
(10) Pub. No.: US 2005/0083597 A1
(43) Pub. Date: Apr. 21, 2005

(54) Device and method for precision alignment and mounting of stamper/imprinter for contact patterning of magnetic recording media

(75) Inventors: Gennady Gauzner, Livermore, CA (US); David Shiao-Min Kuo, Palo Alto, CA (US); Koichi Wago, Sunnyvale, CA (US)

Correspondence Address: MCDERMOTT. WILL & EMERY, 600 13th Street, N.W., Washington, DC, 20005-3096, US

(73) Assignee: SEAGATE TECHNOLOGY LLC

(21) Appl. No.: 10/684,450

(22) Filed: Oct. 15, 2003

(51) Int. Cl. G11B 5/86

(52) U.S. Cl. 360/17; 430/270.1; 430/39

(57) ABSTRACT

A device for precisely aligning a stamper/imprinter for use in a process for contact printing of a magnetic pattern in a surface of a magnetic or magneto-optical (MO) recording medium, comprising: (a) a holding plate having opposed first and second major surfaces; (b) means for positioning and fixedly mounting a stamper/imprinter on the first major surface of the holding plate; (c) a mounting plate having opposed first and second major surfaces, the first major surface of the mounting plate facing the second major surface of the holding plate; and (d) mounting means for positioning and fixedly mounting the first major surface of the mounting plate in contact with the second major surface of the holding plate, including means for laterally moving the holding plate relative to the mounting plate.

### FIELD OF THE INVENTION

The present invention relates to a device and method for precision alignment of a stamper/imprinter utilized for forming magnetic transition patterns in magnetic recording media by means of contact printing. The invention has particular utility in the formation of servo patterns in the surfaces of magnetic recording layers of magnetic and magneto-optical (MO) data/information storage and retrieval media, e.g., hard disks.

### BACKGROUND OF THE INVENTION

Magnetic and magneto-optical (MO) recording media are widely used in various applications, e.g., in hard disk form, particularly in the computer industry, for storage and retrieval of large amounts of data/information. Typically such media require pattern formation in the major surface(s) thereof for facilitating operation, e.g., servo pattern formation for enabling positioning of the read/write transducer head over a particular data band or region.

Magnetic and magneto-optical (MO) recording media are conventionally fabricated in thin film form; the former are generally classified as “longitudinal” or “perpendicular”, depending upon the orientation (i.e., parallel or perpendicular) of the magnetic domains of the grains of the magnetic material constituting the active magnetic recording layer, relative to the surface of the layer.

In operation of magnetic media, the magnetic layer is locally magnetized by a write transducer or write head to record and store data/information. The write transducer creates a highly concentrated magnetic field which alternates direction based on the bits of information being stored. When the local magnetic field applied by the write transducer is greater than the coercivity of the recording medium layer, then the grains of the polycrystalline magnetic layer at that location are magnetized. The grains retain their magnetization after the magnetic field applied by the write transducer is removed. The direction of the magnetization matches the direction of the applied magnetic field. The pattern of magnetization of the recording medium can subsequently produce an electrical response in a read transducer, allowing the stored medium to be read.

A typical contact start/stop (CSS) method employed during use of disk-shaped recording media, such as the above-described thin-film magnetic recording media, involves a floating transducer head gliding at a predetermined distance from the surface of the disk due to dynamic pressure effects caused by air flow generated between mutually sliding surfaces of the transducer head and the disk. During reading and recording (writing) operations, the transducer head is maintained at a controlled distance from the recording surface, supported on a bearing of air as the disk rotates, such that the transducer head is freely movable in both the circumferential and radial directions, thereby allowing data to be recorded and retrieved from the disk at a desired position in a data zone.

Adverting to FIG. 1, shown therein, in simplified, schematic plan view, is a magnetic recording disk 30 (of either longitudinal or perpendicular type) having a data zone 34 including a plurality of servo tracks, and a contact start/stop (CSS) zone 32. A servo pattern 40 is formed within the data zone 34, and includes a number of data track zones 38 separated by servo tracking zones 36. The data storage function of disk 30 is confined to the data track zones 38, while servo tracking zones 36 provide information to the disk drive which allows a read/write head to maintain alignment on the individual, tightly-spaced data tracks.

Although only a relatively few of the servo tracking zones are shown in FIG. 1 for illustrative simplicity, it should be recognized that the track patterns of the media contemplated herein may include several hundreds of servo zones to improve head tracking during each rotation of the disk. In addition, the servo tracking zones need not be straight radial zones as shown in the figure, but may instead comprise arcs, intermittent zones, or irregularly-shaped zones separating individual data tracks.

In conventional hard disk drives, data is stored in terms of bits along the data tracks. In operation, the disk is rotated at a relatively high speed, and the magnetic head assembly is mounted on the end of a support or actuator arm, which radially positions the head on the disk surface. If the actuator arm is held stationary, the magnetic head assembly will pass over a circular path on the disk, i.e., over a data track, and information can be read from or written to that track. Each concentric track has a unique radius, and reading and writing information from or to a specific track requires the magnetic head to be located above that track. By moving the actuator arm, the magnetic head assembly is moved radially on the disk surface between tracks. Many actuator arms are rotatable, wherein the magnetic head assembly is moved between tracks by activating a servomotor which pivots the actuator arm about an axis of rotation. Alternatively, a linear actuator may be used to move a magnetic head assembly radially inwardly or outwardly along a straight line.

As has been stated above, to record information on the disk, the transducer creates and applies a highly concentrated magnetic field in close proximity to the magnetic recording medium. During writing, the strength of the concentrated magnetic field directly under the write transducer is greater than the coercivity of the recording medium, and grains of the recording medium at that location are magnetized in a direction which matches the direction of the applied magnetic field. The grains of the recording medium retain their magnetization after the magnetic field is removed. As the disk rotates, the direction of the writing magnetic field is alternated, based on bits of the information being stored, thereby recording a magnetic pattern on the track directly under the write transducer.

On each track, eight “bits” typically form one “byte” and bytes of data are grouped as sectors. Reading or writing a sector requires knowledge of the physical location of the data in the data zone so that the servo-controller of the disk drive can accurately position the read/write head in the correct location at the correct time. Most disk drives use disks with embedded “servo patterns” of magnetically readable information. The servo patterns are read by the magnetic head assembly to inform the disk drive of track location. In conventional disk drives, tracks typically include both data sectors and servo patterns and each servo pattern typically includes radial indexing information, as well as a “servo burst”. A servo burst is a centering pattern to precisely position the head over the center of the track. Because of the locational precision needed, writing of servo patterns requires expensive servo-pattern writing equipment and is a time-consuming process.

Co-pending, commonly assigned U.S. patent application Ser. No. 10/082,178, filed Feb. 26, 2002 (Attorney Docket No. 50103-401), the entire disclosure of which is incorporated herein by reference, discloses a method and apparatus for reliably, rapidly, and cost-effectively forming very sharply defined magnetic transition patterns in a magnetic medium containing a longitudinal or perpendicular type magnetic recording layer without requiring expensive, complicated servo writing equipment/techniques incurring long processing intervals.

Specifically, the invention disclosed in U.S. patent application Ser. No. 10/082,178 is based upon recognition that a stamper/imprinter comprised of a magnetic material having a high saturation magnetization, Bₛₐₜ, i.e., Bₛₐₜ≧ about 0.5 Tesla, and a high permeability, μ, i.e., μ≧ about 5, e.g., selected from Ni, NiFe, CoNiFe, CoSiFe, CoFe, and CoFeV, can be effectively utilized as a contact “stamper/imprinter” for contact “imprinting” of a magnetic transition pattern, e.g., a servo pattern, in the surface of a magnetic recording layer of a magnetic medium (“workpiece”), whether of longitudinal or perpendicular type. A key feature of this invention is the use of a stamper/imprinter having an imprinting surface including a topographical pattern, i.e., comprised of projections and depressions corresponding to a desired magnetic transition pattern, e.g., a servo pattern, to be formed in the magnetic recording layer. An advantage afforded by the invention is the ability to fabricate the topographically patterned imprinting surface of the stamper/imprinter, as well as the substrate or body therefor, of a single material, as by use of well-known and economical electro-forming techniques.

According to the invention, the magnetic domains of the magnetic recording layer of the workpiece are first unidirectionally aligned (i.e., “erased” or “initialized”), as by application of a first external, unidirectional magnetic field Hᵢₙᵢₜᵢₐₗ of first direction and high strength greater than the saturation field of the magnetic recording layer, typically ≧2,000 and up to about 20,000 Oe. The imprinting surface of the stamper/imprinter is then brought into intimate (i.e., touching) contact with the surface of the magnetic recording layer. With the assistance of a second externally applied magnetic field of second, opposite direction and lower but appropriate strength H_{re-align}, determined by Bₛₐₜ/μof the stamper material (typically ≧100 Oe, e.g., from about 2,000 to about 4,500 Oe), the alignment of the magnetic domains at the areas of contact between the projections of the imprinting surface of the stamper/imprinter (in the case of perpendicular recording media, as schematically illustrated in FIG. 2) or at the areas facing the depressions of the imprinting surface of the stamper/imprinter (in the case of longitudinal recording media, as schematically illustrated in FIG. 3) and the magnetic recording layer of the workpiece is selectively reversed, while the alignment of the magnetic domains at the non-contacting areas (defined by the depressions in the imprinting surface of the stamper/imprinter) or at the contacting areas, respectively, is unaffected, whereby a sharply defined magnetic transition pattern is created within the magnetic recording layer of the workpiece to be patterned which essentially mimics, or replicates, the topographical pattern of projections and depressions of the imprinting surface. According to the invention, high Bₛₐₜ and high μ materials are preferred for use as the stamper/imprinter in order to: (1) avoid early magnetic saturation of the stamper/imprinter at the contact points between the projections of the imprinting surface and the magnetic recording layer, and (2) provide an easy path for the magnetic flux lines which enter and/or exit at the side edges of the projections.

Stampers/imprinters for use in a typical application, e.g., servo pattern formation in the recording layer of a disk-shaped, thin film, longitudinal or perpendicular magnetic recording medium comprise an imprinting surface having topographical features consisting of larger area data zones separated by smaller areas with well-defined patterns of projections and depressions corresponding to conventionally configured servo sectors, as for example, disclosed in commonly assigned U.S. Pat. No. 5,991,104, the entire disclosure of which is incorporated herein by reference. For example, a suitable topography for forming the servo sectors may comprise a plurality of projections (alt. depressions) having a height (alt. depth) in the range from about 100 to about 500 nm, a width in the range from about 50 to about 500 nm, and a spacing in the range from about 50 to about 500 nm.

Stampers/imprinters suitable for use in performing the foregoing patterning processes are typically manufactured by a sequence of steps which include providing a “master” comprised of a substantially rigid substrate with a patterned layer of a resist material thereon, the pattern comprising a plurality of projections and depressions corresponding (in positive or negative image form, as necessary) to the desired pattern to be formed in the surface of the stamper/imprinter. Stampers/imprinters are made from the master by initially forming a thin, conformal layer of an electrically conductive, magnetic material (e.g., Ni) over the patterned resist layer and then electro-forming a substantially thicker (“blanket”) magnetic layer (of the aforementioned magnetic metals and/or alloys) on the thin layer of electrically conductive material, which electro-formed blanket layer replicates the surface topography of the resist layer. Upon completion of the electro-forming process, the stamper/imprinter, termed a “father” is separated from the master, and is then in turn used for making a “family” of stampers/imprinters, including one or more “mother” and “son” stampers/imprinters.

Currently, contact printing for servo patterning of magnetic media is performed disk at-a-time, which practice requires steps for placing and properly aligning a magnetic stamper/imprinter disk in contact with a surface of the magnetic medium, e.g., a hard disk, in a suitable contact printing device comprising a magnet means, and applying an appropriately directed magnetic field from the magnet means to the stamper/imprinter for forming a magnetic image of the topographically patterned imprinting surface of the magnetic stamper/imprinter on a surface of the disk. In common practice, magnetic patterns are formed on formed on both sides of the disk, since dual-sided disks are standard in the hard drive industry.

Precise alignment of the stamper(s)/imprinter(s), relative to the disk surface(s), is essential for performing the above-described process for contact patterning, e.g., servo patterning, of magnetic media. Some systems for servo patterning of magnetic media utilizing contact printing techniques employ an alignment tool having a center hub for accommodating/aligning an annular disk-shaped stamper/imprinter via the central opening of the disk. Such systems, however, disadvantageously require the stamper/imprinter to be physically placed on the center hub within the alignment tool. Additional disadvantages of the hub-type alignment tools include the following:
1. accuracy of the alignment is limited by the accuracy of the method used for forming (punching) the central opening of the annular disk. The eccentricity between the central opening and the pattern data, and the dimensional tolerances of the central opening, each affect the ultimate alignment of the stamper/imprinter;
2. the center hub of the alignment tool, on which the annular disk-shaped stamper/imprinter is mounted via its central opening, has its own dimensional tolerances;
3. the center hub of the alignment tool is movable, which movement introduces additional dimensional tolerances; and
4. the central opening of the annular disk-shaped stamper/imprinter must be slightly larger than the center hub of the alignment tool in order to allow for placement/installation of the stamper/imprinter in the alignment tool.

In practice, the effects of each of the individually-enumerated dimensional tolerances are additive, and as a consequence, accuracy of the alignment of the stamper/imprinter in the alignment tool is limited. In addition to the above, contamination of the stamper/imprinter and the contact imprinted/patterned disks is possible during the contact imprinting/patterning process as a result of frictional contact, i.e., rubbing, of the edge of the stamper/imprinter on the moving center hub of the alignment tool.

In view of the foregoing drawbacks associated with existing means and methodology for accurately and precisely aligning stampers/imprinters for contact patterning of magnetic media in alignment tools, there exists a need for means and methodology for performing accurate and precise alignment of the stampers/imprinters as part of a process for patterning (e.g., servo patterning) magnetic and/or MO recording media by contact printing which are free of the above-described drawbacks and disadvantages associated with the use of the existing means and methodology, in order to facilitate high quality, high throughput replication of precisely aligned patterns (e.g., servo patterns) in dual-sided magnetic and/or MO disk recording media via contact printing.

The present invention addresses and solves the above-described problems, disadvantages, and drawbacks associated with existing means and methodologies for servo pattern formation in thin film magnetic and/or MO recording media, particularly in disk form, while maintaining full compatibility with the requirements of automated hard disk manufacturing technology.

### DISCLOSURE OF THE INVENTION

An advantage of the present invention is an improved device for precisely aligning a stamper/imprinter for use in a process for contact printing of a magnetic pattern in a surface of a magnetic or magneto-optical (MO) recording medium.

Another advantage of the present invention is an improved method for precisely aligning a stamper/imprinter utilized for performing contact printing of a magnetic pattern in the surface of a magnetic or magneto-optical (MO) recording medium.

Yet another advantage of the present invention is an improved method for precisely aligning a stamper/imprinter utilized for performing contact printing of a servo pattern in the surface of a magnetic or magneto-optical (MO) recording medium.

Additional advantages and other features of the present invention will be set forth in the description which follows and in part will become apparent to those having ordinary skill in the art upon examination of the following or may be learned from the practice of the present invention. The advantages of the present invention may be realized and obtained as particularly pointed out in the appended claims.

According to an aspect of the present invention, the foregoing and other advantages are obtained in part by a device for precisely aligning a stamper/imprinter for use in a process for contact printing of a magnetic pattern in a surface of a magnetic or magneto-optical (MO) recording medium, comprising:
(a) a holding plate having opposed first and second major surfaces;
(b) means for positioning and fixedly mounting a stamper/imprinter on the first major surface of the holding plate;
(c) a mounting plate having opposed first and second major surfaces, the first major surface of the mounting plate facing the second major surface of the holding plate; and
(d) mounting means for positioning and fixedly mounting the first major surface of the mounting plate in contact with the second major surface of the holding plate, the mounting means including means for laterally moving the holding plate relative to the mounting plate.

According to preferred embodiments of the present invention, the means for fixedly mounting a stamper/imprinter on the first major surface of the holding plate includes vacuum means and mechanical means; wherein the vacuum means comprises a plurality of channels formed in the mounting plate, and each of the plurality of channels terminates as a suction means at the first major surface of the mounting plate, the suction means adapted for fastening to a rear surface of a stamper/imprinter; the mechanical means comprises a plurality of micrometer screw means or a plurality of spring-biased means adapted for urging against a peripheral edge of a stamper/imprinter, or the mechanical means comprises at least one of clamps, brackets, flanges, or holding rings; the mounting means for positioning and fixedly mounting the first major surface of the mounting plate in contact with the second major surface of the holding plate and for varying the lateral position of the holding plate relative to the mounting plate, includes pressure varying means for selectively applying negative or positive air pressure to the holding plate and mechanical means, wherein the pressure varying means comprises a plurality of channels formed in and extending to the first major surface of the mounting plate, and the mechanical means comprises a plurality of micrometer screw means or a plurality of spring-biased means adapted for urging against a peripheral edge of the holding plate, or the mechanical means comprises at least one of clamps, brackets, flanges, or holding rings.

Further preferred embodiments of the invention include those wherein the holding plate and the mounting plate are annular disks, the outer diameter of the mounting plate being greater than the outer diameter of the holding plate, and wherein the device further comprises an annular disk-shaped resilient pad atop the first major surface of the holding plate, the outer diameter of the resilient pad being less than that of the holding plate.

Still further preferred embodiments of the present invention include those herein the device further comprises:
(e) an alignment means for use in positionally aligning the tamper/imprinter by laterally moving the holding plate relative to the mounting late, wherein the alignment means comprises optical means.

Another aspect of the present invention is a method for precisely aligning a stamper/imprinter utilized for performing contact printing of a magnetic pattern in the surface of a magnetic or magneto-optical (MO) recording medium, comprising sequential steps of:
(a) providing a device including:
   (i) a holding plate having opposed first and second major surfaces;
   (ii) means for positioning and fixedly mounting a stamper/imprinter on the first major surface of the holding plate;
   (iii) a mounting plate having opposed first and second major surfaces, the first major surface of the mounting plate facing the second major surface of the holding plate;
   (iv) mounting means for positioning and fixedly mounting the first major surface of the mounting plate in contact with the second major surface of the holding plate, the mounting means including means for laterally moving the holding plate relative to the mounting plate; and
   (v) alignment means for use in laterally aligning the stamper/imprinter;
(b) providing a stamper/imprinter having a topographically patterned imprinting front surface and a rear surface;
(c) positioning and fixedly mounting the rear surface of the stamper/imprinter to the first major surface of the holding plate, such that the topographically patterned imprinting front surface is outwardly facing;
(d) placing the second major surface of the holding plate in contact with the first major surface of the mounting plate;
(e) facilitating lateral movement of the holding plate relative to the mounting plate;
(f) determining a positionally aligned position of the stamper/imprinter utilizing the alignment means;
(g) laterally moving the mounting plate with the stamper/imprinter mounted thereon to the aligned position; and
(h) fixedly mounting the mounting plate with the stamper/imprinter mounted thereon in the aligned position.

According to preferred embodiments of the present invention, the method comprises a further step of:
(j) installing the device with the mounted and aligned stamper/imprinter in a contact patterning apparatus and performing contact patterning of a magnetic or MO recording medium utilizing the apparatus.

Further preferred embodiments of the present invention include those wherein step (a) comprises providing a device wherein the holding plate and the mounting plate are annular disks, the outer diameter of the mounting plate being greater than the outer diameter of the holding plate; and step (b) comprises providing an annular disk-shaped stamper/imprinter having an outer diameter smaller than the outer diameters of the holding plate and the mounting plate.

In accordance with especially preferred embodiments of the present invention, step (b) comprises providing a stamper/imprinter having a topographically patterned imprinting surface comprising a plurality of spaced-apart recesses with a plurality of non-recessed areas therebetween, the topographical pattern corresponding to a servo pattern to be formed in the surface of the magnetic or MO recording medium; wherein step (b) comprises providing a stamper/imprinter having a topographically patterned imprinting surface comprised of at least one magnetic material having a high saturation magnetization Bₛₐₜ≧˜0.5 Tesla and a high permeability μ≧˜5, selected from the group consisting of Ni, NiFe, CoNiFe, CoSiFe, CoFe, and CoFeV.

According to still further preferred embodiments according to the invention, step (c) comprises positioning and fixedly mounting the stamper/imprinter to the first major surface of the holding plate utilizing vacuum means and mechanical means; wherein step (c) comprises utilizing vacuum means comprising a plurality of channels formed in the mounting plate and terminating as suction means at the first major surface, and mechanical means comprising a plurality of micrometer screw means or spring-biased means adapted for urging against a peripheral edge of the stamper/imprinter, or mechanical means comprising at least one of clamps, brackets, flanges, or holding rings.

Still further preferred embodiments of the present invention include those wherein step (e) comprises facilitating lateral movement of the holding plate relative to the mounting plate by supplying a positive gas pressure to a plurality of channels formed in and extending to the first major surface of the mounting plate; step (f) comprises determining the positionally aligned position of the mounting plate with the stamper/imprinter mounted thereon by means of an optical alignment means; and step (h) comprises fixedly mounting the mounting plate with the stamper/imprinter mounted thereon in the aligned position by supplying a negative gas pressure to a plurality of channels formed in and extending to the first major surface of the mounting plate, and utilizing a plurality of micrometer screw means or spring-biased means adapted for urging against a peripheral edge of the holding plate, or utilizing mechanical means comprising at least one of clamps, brackets, flanges, or holding rings.

Additional advantages and aspects of the present invention will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the various features are not necessarily drawn to scale but rather are drawn as to best illustrate the pertinent features and the same reference numerals are utilized throughout to designate similar features, wherein:

FIG. 1 illustrates in simplified, schematic plan view, a magnetic recording disk designating the data, servo pattern, and CSS zones thereof;

FIG. 2 illustrates, in schematic, simplified cross-sectional view, a sequence of process steps for contact printing a magnetic transition pattern in the surface of a perpendicular magnetic recording layer, utilizing a stamper/imprinter formed of a high saturation magnetization (Bₛₐₜ), high permeability (μ) magnetic material having an imprinting surface with a surface topography corresponding to the desired magnetic transition pattern;

FIG. 3 illustrates, in schematic, simplified cross-sectional view, a similar sequence of process steps for contact printing a magnetic transition pattern in the surface of a longitudinal magnetic recording layer; and

FIGS. 4(A) and 4(B) illustrate, in schematic, simplified cross-sectional and plan views, respectively, a device for precisely aligning stampers/imprinters utilized for contact patterning of a recording medium, according to an embodiment of the present invention.

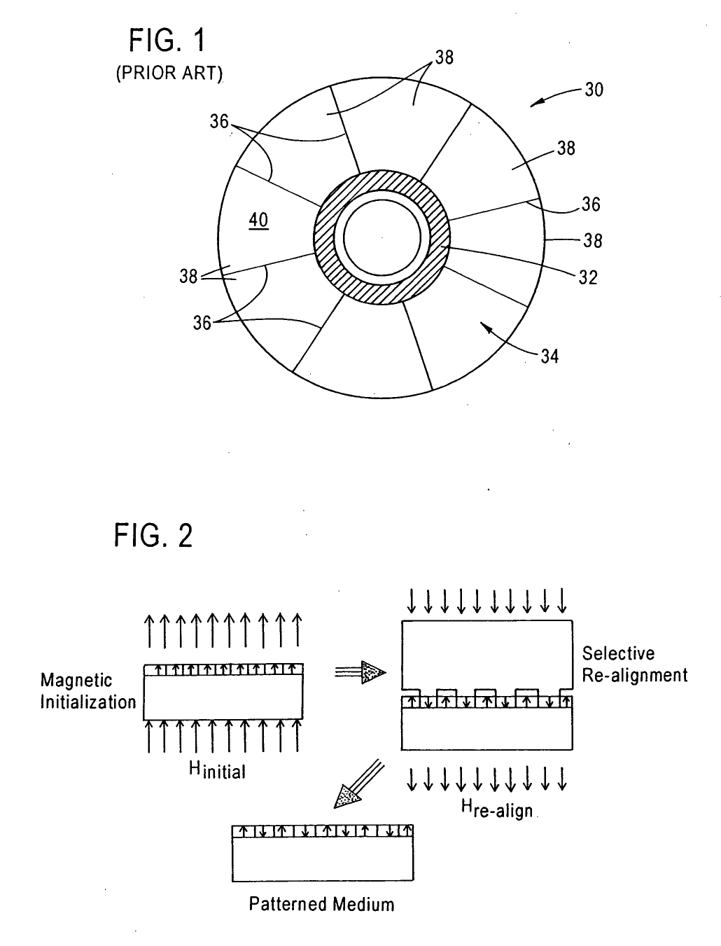

### DESCRIPTION OF THE INVENTION

The present invention addresses and solves problems attendant upon the use of topographically patterned stampers/imprinters, e.g., magnetic stampers/imprinters for contact printing of magnetic patterns, such as servo patterns, in the surfaces of disk-shaped magnetic and magneto-optical (MO) recording media. Specifically, the present invention has, as principal aims, provision of devices and methods for precise alignment of the topographical pattern(s) of the stamper(s)/imprinter(s) relative to the media surfaces, which devices and methods do not incur the above-described disadvantages and drawbacks associated with hub-based alignment tools/systems. As indicated supra, the disadvantages and drawbacks of hub-based alignment systems include manual placement of the stamper/imprinter on a central hub of the alignment tool, eccentricity between the central opening of the stamper/imprinter and the topographical pattern of the imprinting surface, and dimensional tolerances of the central hub of the alignment tool and the central opening of the stamper/imprinter. The devices and methods of the present invention facilitate high quality, high replication fidelity patterning, e.g., servo patterning, of magnetic and MO recording media by contact printing with topographically patterned stampers/imprinters, while maintaining full compatibility with all requirements of automated manufacturing technology for manufacture of magnetic and MO recording media.

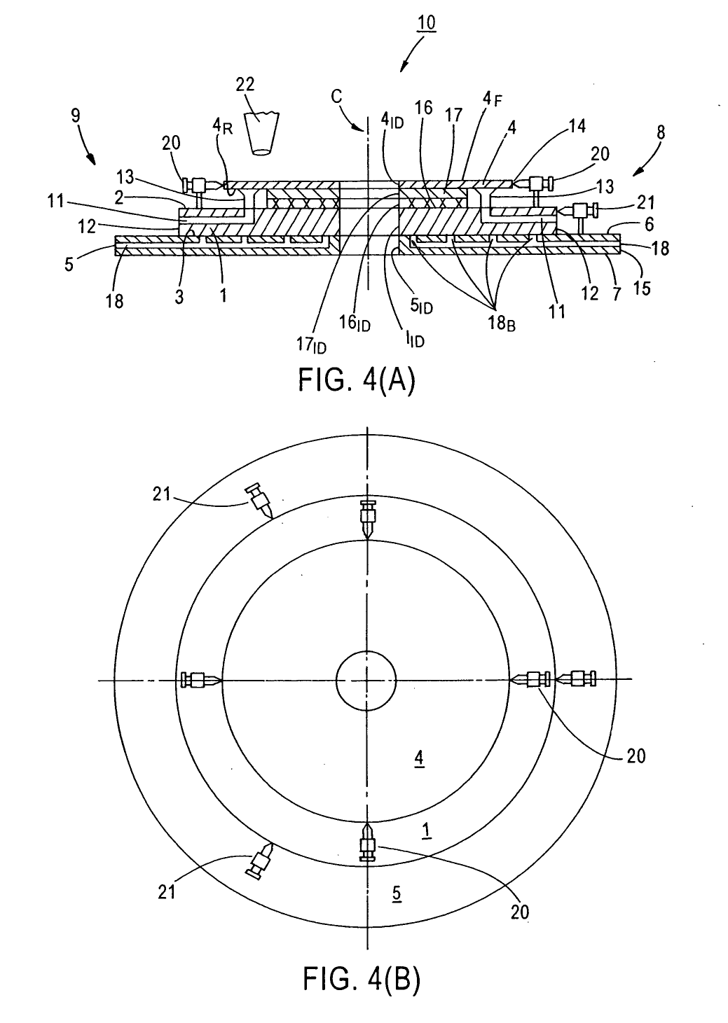

Referring now to FIGS. 4(A) and 4(B), illustrated therein, in schematic, simplified cross-sectional and plan views, respectively, is a device 10 for precisely aligning the topographical patterns of stampers/imprinters utilized for contact patterning of a recording medium, e.g., an annular disk-shaped magnetic or MO medium, according to an embodiment of the present invention. It should be noted that while the illustrated device 10 is oriented in a generally horizontal direction, operation is possible with other, non-horizontal orientations. In addition, unless otherwise noted, the various components/elements of device 10 are each comprised of a mechanically robust non-magnetic material, such as a non-magnetic metal or alloy.

As illustrated, device 10 is generally circularly-shaped in plan view and comprises a first annular disk-shaped plate member 1 (illustratively, an upper plate), termed a “holding plate”, including a first (illustratively, upper) major surface 2 including means 8 for positionally aligning and mounting thereon an annular disk-shaped stamper/imprinter 4 of outer diameter (OD) 14 smaller than the OD 12 of holding plate 1, and an oppositely facing second (illustratively, lower) major surface 3. Second annular disk-shaped plate member 5 (illustratively, a lower plate), termed a “mounting plate”, has a larger OD 15 than OD 12 of holding plate 1 and includes a first (illustratively, upper) major surface 6 including means 9 for positionally aligning and mounting holding plate 1 thereon, and an oppositely facing second (illustratively, lower) major surface 7, adapted for securing device 10 to a suitable contact printing tool (not shown). Each of the annular disk-shaped stamper/imprinter 4, holding plate 1, and mounting plate 5 are concentric about central axis c, with substantially equal inner diameters (IDs) 4_{ID}, 1_{ID}, and 5_{ID}, respectively.

Annular disk-shaped stamper/imprinter 4 includes a first, or front, major surface 4_{F} (illustratively, an upper surface) including a topographically patterned central region, typically corresponding to a servo pattern to be formed in the surface of an annular disk-shaped magnetic or MO recording medium, and an oppositely facing second, or rear, surface 4_{R} (illustratively, a lower surface). Means 8 for positionally aligning and mounting stamper/imprinter 4 on the first (upper) major surface 2 of holding plate 1 include a plurality of channels 11 formed in the latter, each channel: (1) adapted to be connected to a source of vacuum; (2) originating at the perimeter (OD) 12 of holding plate 1; (3) extending radially inwardly within plate 1 for a distance; (4) terminating at the first (upper) major surface 2 of holding plate 1; and (5) fluidly connected at the first (upper) major surface 2 of holding plate 1 to a gripping means 13, e.g., a suction cup, for attaching to the rear surface 4_{R} of stamper/imprinter 4 to thereby immobilize the latter when channels 11 are operatively connected to the source of vacuum. Means 8 further includes a plurality of mechanical fixing means 20, e.g., micrometer screw means or spring-biased means, arranged around the OD 12 (i.e., perimeter) of holding plate 1, which mechanical fixing means 20 are urged into engaging contact with the OD 14 (i.e., perimeter) of the stamper/imprinter 4 for securely and fixedly maintaining lateral alignment thereof with holding plate 1. The edge of OD 14 (perimeter) of the stamper/imprinter 4 may, if desired, be provided with a beveled indentation for mating with a correspondingly beveled protrusion of the mechanical fixing means 20 for facilitating the mechanical fixing. Alternatively, the mechanical fixing means 20 may comprise at least one of clamps, brackets, flanges, and holding rings. Finally, means 8 include an overlying pair of annular disks positioned intermediate the first (upper) major surface 2 of the holding plate 1 and the rear (lower) surface 4_{R} of the stamper/imprinter 4, including a first disk 16 of a metal, e.g., Al, adjacent the first (upper) major surface 2 of holding plate 1, and second disk 17 of a compressively resilient elastomeric material, e.g., rubber, adjacent the rear (lower) surface 4_{R} of the stamper/imprinter 4. Annular disk-shaped first and second disks 16 and 17, respectively, may, as illustrated, be concentric about central axis c, with respective IDs 16_{ID} and 17_{ID} substantially equal to the respective IDs 4_{ID}, 1_{ID}, and 5_{ID} of stamper/imprinter 4, holding plate 1, and mounting plate 5. The ODs of the first and second disks 16 and 17, respectively, are each less than the OD 14 of stamper/imprinter, in order to enable contact between the suction cup gripping means 13 of means 8 and the rear (lower) surface 4_{R} of the stamper/imprinter 4.

Means 9 for positionally aligning and fixedly mounting holding plate 1 on mounting plate 5 includes a plurality of channels 18 formed within the latter, each channel: (1) connected to a means adapted for selectively supplying a positive gas pressure (e.g., compressed air) or a negative gas pressure (i.e., a vacuum) to the channel; (2) each channel 18 originating at the OD 15 of plate 5; (3) extending radially inwardly within plate 5 towards the ID 51D; and (4) including a plurality of branch portions 18_{B} extending to the first (upper) major surface 6 of plate 5. Means 9 further includes a plurality of mechanical fixing means 21, e.g., micrometer screw means or spring-biased means, arranged around the OD 15 (i.e., perimeter) of mounting plate 5, which mechanical fixing means 21 are urged into engaging contact with the OD 12 (i.e., perimeter) of the holding plate 1 for securely and fixedly maintaining lateral alignment thereof with mounting plate 5. The edge of the OD 12 (perimeter) of the mounting plate 12 may, if desired, be provided with a beveled indentation for mating with a correspondingly beveled protrusion of the mechanical fixing means 21 for facilitating the mechanical fixing. As with mechanical means 20, mechanical means 21 may comprise at least one of clamps, brackets, flanges, and holding rings.

Finally, device 10 includes an optical alignment means 22, e.g., a laser beam device, positioned above the stamper/imprinter 4, for providing direct optical alignment of the topographical pattern of the stamper/imprinter 4 during mounting of the holding plate 1 (with stamper/imprinter 4 thereon) on mounting plate 5.

In typical operation of device 10, a suitably topographically patterned stamper/imprinter 4 is placed with its rear surface 4_{R} in contact with the first major (upper) surface 2 of the holding plate 1, maintained in place by means of vacuum supplied to the suction cups 13 via channels 11, and fixed in position by the micrometer screw or spring-biased means 20. The holding plate 1 with stamper/imprinter 4 fixedly mounted thereon is then aligned with respect to the mounting plate 5 utilizing the laser beam alignment device 22 and micrometer heads. Compressed air is supplied to channels 18 during the alignment process to create an air bearing between the holding and mounting plates in order to facilitate relative (lateral) movement therebetween. When proper positional alignment is achieved, as indicated by the laser beam alignment device 22, the supply of compressed air to the channels 18 is terminated and replaced with a vacuum to maintain the alignment during mechanical fixing of the holding plate 1 (with stamper/imprinter 4 fixedly mounted thereon) to the mounting plate 5 by means of the micrometer screw or spring-biased means 21. Device 10 with the positionally aligned stamper/imprinter 4 is then installed in a suitable contact printing tool for use in contact patterning magnetic and/or MO recording media, as described above.

The invention differs from previous methodologies and instrumentalities for performing contact patterning of magnetic and/or MO recording media in that it allows for direct optical alignment of the topographical pattern of the stamper/imprinter, which process is not limited by the dimensional tolerances of the central opening of the stamper/imprinter and a central hub of the mounting device, due to elimination of the need for the latter. In addition, the invention facilitates use, if desired, of thinner stampers/imprinters, e.g., 0.15 mm thick, instead of the conventional 0.30 mm.

According to preferred embodiments of the invention, annular disk-shaped magnetic or magneto-optical (MO) recording medium including at least one layer of a magnetic recording material on at least one surface of a substrate comprised of a non-magnetic material selected from the group consisting of Al, NiP-plated Al, Al—Mg alloys, other Al-based alloys, other non-magnetic metals, other non-magnetic metal-based alloys, glass, ceramics, polymers, glass-ceramics, and composites or laminates of the aforementioned materials, are subjected to servo patterning by means of contact printing utilizing the inventive methodology and device, wherein the stamper/imprinter has an annular disk-shaped, topographically patterned imprinting surface comprised of at least one magnetic material having high saturation magnetization Bₛₐₜ≧˜0.5 Tesla and high permeability μ≧˜5, selected from the group consisting of Ni, NiFe, CoNiFe, CoSiFe, CoFe, and CoFeV, the topographically patterned imprinting surface comprising a patterned plurality of spaced-apart recesses with a plurality of non-recessed areas therebetween, the topographical pattern corresponding to the servo pattern to be formed in the surface of the recording medium.

The methodology and device of the present invention are useful in performing contact patterning of perpendicular magnetic recording media, as illustrated in FIG. 2, in which the magnetic domains have been unidirectionally aligned in a first direction by applying a first unidirectional magnetic field thereto in a first direction perpendicular to the upper and lower surfaces of the recording medium; and the process comprises selectively re-aligning the direction of alignment of the magnetic domains of those portions of the surface of the recording medium which are in contact with the projections of the topographically patterned imprinting surfaces of the magnetic stamper/imprinter by generating a unidirectional DC magnetic field between upper and lower magnetic poles in a second, opposite direction perpendicular to the surface of the recording medium.

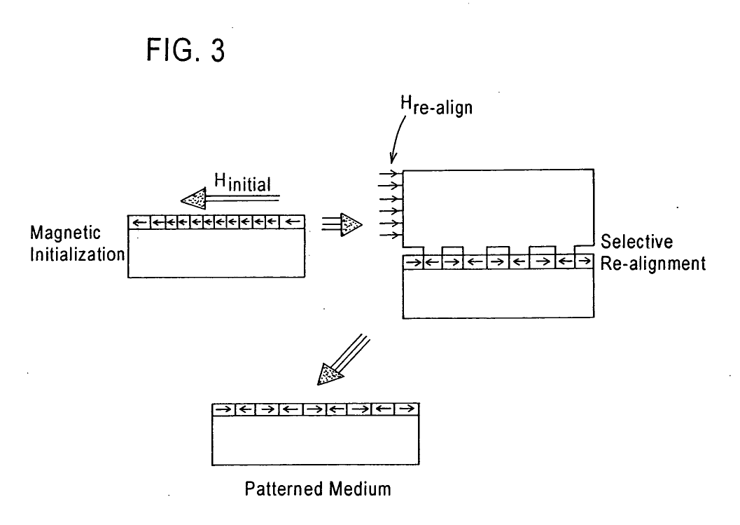

The methodology and device of the present invention are similarly useful in performing contact patterning of longitudinal magnetic recording media, as illustrated in FIG. 3, in which the magnetic domains have been unidirectionally aligned in a first direction by applying a first unidirectional magnetic field thereto in a first direction parallel to the upper and lower surfaces of the recording medium; and the process comprises selectively re-aligning the direction of alignment of the magnetic domains of those portions of the surface of the recording medium which are in contact with the depressions of the topographically patterned imprinting surfaces of the magnetic stamper/imprinter by generating a unidirectional DC magnetic field in a second, opposite direction parallel to the surfaces of the recording medium.

It should be apparent to one of ordinary skill in the art that the present invention, by virtue of the use of an alignment device comprising separate holding and mounting plates, and optical alignment means, provides a significant improvement over the conventional art such as has been described above, particularly with respect to the precision alignment of the topographical pattern. Further, the imprinting surfaces of the stampers/imprinters according to the invention can be formed with a wide variety of topographical patterns, whereby the inventive methodology can be rapidly, easily, and cost-effectively implemented in the automated manufacture of a number of magnetic articles, devices, etc., requiring patterning, of which servo patterning of perpendicular magnetic recording media constitute but one example of the versatility and utility of the invention.

In the previous description, numerous specific details are set forth, such as specific materials, structures, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disclosure. It is to be understood that the present invention is capable of use in other combinations and environments and is susceptible of changes and/or modifications within the scope of the inventive concept as expressed herein.

1. A device for precisely aligning a stamper/imprinter for use in a process for contact printing of a magnetic pattern in a surface of a magnetic or magneto-optical (MO) recording medium, comprising:
(a) a holding plate having opposed first and second major surfaces;
(b) means for positioning and fixedly mounting a stamper/imprinter on said first major surface of said holding plate;
(c) a mounting plate having opposed first and second major surfaces, said first major surface of said mounting plate facing said second major surface of said holding plate; and
(d) mounting means for positioning and fixedly mounting said first major surface of said mounting plate in contact with said second major surface of said holding plate, said mounting means including means for laterally moving said holding plate relative to said mounting plate.

2. The device according to claim 1, wherein:
said means for positioning and fixedly mounting a stamper/imprinter on said first major surface of said holding plate includes vacuum means and mechanical means.

3. The device according to claim 2, wherein:
said vacuum means comprises a plurality of channels formed in said mounting plate.

4. The device according to claim 3, wherein:
each of said plurality of channels terminates as a suction means at said first major surface of said mounting plate, said suction means adapted for fastening to a rear surface of a stamper/imprinter.

5. The device according to claim 2, wherein:
said mechanical means comprises a plurality of micrometer screw means or a plurality of spring-biased means adapted for urging against a peripheral edge of a stamper/imprinter, or said mechanical means comprises at least one of clamps, brackets, flanges, and holding rings.

6. The device according to claim 1, wherein:
said positioning mounting means for positioning and fixedly mounting said first major surface of said mounting plate in contact with said second major surface of said holding plate and for varying the lateral position of said holding plate relative to said mounting plate, includes pressure varying means for selectively applying negative or positive air pressure to said holding plate and mechanical means.

7. The device according to claim 6, wherein:
said pressure varying means comprises a plurality of channels formed in and extending to said first major surface of said mounting plate.

8. The device according to claim 6, wherein:
said mechanical means comprises a plurality of micrometer screw means or a plurality of spring-biased means adapted for urging against a peripheral edge of said holding plate, or said mechanical means comprises at least one of clamps, brackets, flanges, and holding rings.

9. The device according to claim 1, wherein:
said holding plate and said mounting plate are annular disks, the outer diameter of said mounting plate being greater than the outer diameter of said holding plate.

10. The device according to claim 9, wherein:
said device further comprises an annular disk-shaped resilient pad atop said first major surface of said holding plate, the outer diameter of said resilient pad being less than that of said holding plate.

11. The device according to claim 1, further comprising:
(e) an alignment means for use in positionally aligning said stamper/imprinter by laterally moving said holding plate relative to said mounting plate.

12. The device according to claim 11, wherein:
said alignment means comprises optical means.

13. A method for precisely aligning a stamper/imprinter utilized in performing contact printing of a magnetic pattern in the surface of a magnetic or magneto-optical (MO) recording medium, comprising sequential steps of:
(a) providing a device including:
(i) a holding plate having opposed first and second major surfaces;
(ii) means for positioning and fixedly mounting a stamper/imprinter on said first major surface of said holding plate;
(iii) a mounting plate having opposed first and second major surfaces, said first major surface of said mounting plate facing said second major surface of said holding plate;
(iv) mounting means for positioning and fixedly mounting said first major surface of said mounting plate in contact with said second major surface of said holding plate, said mounting means including means for laterally moving said holding plate relative to said mounting plate; and
(v) alignment means for use in laterally aligning said stamper/imprinter;
(b) providing a stamper/imprinter having a topographically patterned imprinting front surface and a rear surface;
(c) positioning and fixedly mounting said rear surface of said stamper/imprinter to said first major surface of said holding plate, such that said topographically patterned imprinting front surface is outwardly facing;
(d) placing said second major surface of said holding plate in contact with said first major surface of said mounting plate;
(e) facilitating lateral movement of said holding plate relative to said mounting plate;
(f) determining a positionally aligned position of said stamper/imprinter utilizing said alignment means;
(g) laterally moving said holding plate with said stamper/imprinter mounted thereon to said aligned position; and
(h) fixedly mounting said holding plate with said stamper/imprinter mounted thereon in said aligned position.

14. The method as in claim 13, comprising a further step of:
(j) installing said device with said mounted and aligned stamper/imprinter in a contact patterning apparatus and performing contact patterning of a magnetic or MO recording medium utilizing said apparatus.

15. The method as in claim 13, wherein:
step (a) comprises providing a device wherein said holding plate and said mounting plate are annular disks, the outer diameter of said mounting plate being greater than the outer diameter of said holding plate; and
step (b) comprises providing an annular disk-shaped stamper/imprinter having an outer diameter smaller than the outer diameters of said holding plate and said mounting plate.

16. The method as in claim 13, wherein:
step (b) comprises providing a stamper/imprinter having a topographically patterned imprinting surface comprising a plurality of spaced-apart recesses with a plurality of non-recessed areas therebetween, said topographical pattern corresponding to a servo pattern to be formed in said surface of said magnetic or MO recording medium.

17. The method as in claim 16, wherein:
step (b) comprises providing a stamper/imprinter having a topographically patterned imprinting surface comprised of at least one magnetic material having a high saturation magnetization Bₛₐₜ≧˜0.5 Tesla and a high permeability μ≧˜5, selected from the group consisting of Ni, NiFe, CoNiFe, CoSiFe, CoFe, and CoFeV.

18. The method as in claim 13, wherein:
step (c) comprises positioning and fixedly mounting said stamper/imprinter to said first major surface of said holding plate utilizing vacuum means and mechanical means.

19. The method as in claim 18, wherein:
step (c) comprises utilizing:
(i) vacuum means comprising a plurality of channels formed in said mounting plate and terminating as suction means at said first major surface, and
(ii) mechanical means comprising a plurality of micrometer screw means or spring-biased means adapted for urging against a peripheral edge of said stamper/imprinter, or mechanical means comprising at least one of clamps, brackets, flanges, and holding rings.

20. The method as in claim 13, wherein:
step (e) comprises facilitating lateral movement of said holding plate relative to said mounting plate by supplying a positive gas pressure to a plurality of channels formed in and extending to said first major surface of said mounting plate.

21. The method as in claim 13, wherein:
step (f) comprises determining said aligned position of said mounting plate with said stamper/imprinter mounted thereon by means of an optical alignment means.

22. The method as in claim 13, wherein:
step (h) comprises fixedly mounting mounting plate with said stamper/imprinter mounted thereon in said aligned position by:
(i) supplying a negative gas pressure to a plurality of channels formed in and extending to said first major surface of said mounting plate; and
(ii) utilizing a plurality of micrometer screw means or spring-biased means adapted for urging against a peripheral edge of said holding plate, or utilizing at least one of clamps, brackets, flanges, and holding rings.
